(19) United States
(12) Patent Application Publication
(10) Pub. No.: US 2015/0007484 A1
(43) Pub. Date: Jan. 8, 2015

(54) Method and Apparatus for Fishing Lure Made With Sugar

(71) Applicant: D&J Plastics, Inc., Georgetown, GA (US)

(72) Inventor: Dennis Montgomery, Georgetown, GA (US)

(73) Assignee: D&J Plastics, Inc., Georgetown, GA (US)

(21) Appl. No.: 14/325,964

(22) Filed: Jul. 8, 2014

Related U.S. Application Data
(60) Provisional application No. 61/843,728, filed on Jul. 8, 2013.

(51) Int. Cl. A01K 85/16; B29C 45/18; B29C 45/00; B29C 45/76

(52) U.S. Cl. CPC A01K 85/16; B29C 45/76; B29C 45/1816; B29C 45/1858; B29C 45/0001; B29C 2045/465
USPC 43/42.24; 425/166; 425/200; 264/78; 264/255; 264/328.1; 264/328.14; 264/328.17

(57) ABSTRACT

A system, method and apparatus are provided for a fishing lure made with sugar. The system includes a mixing vat, a mixing mechanism, a mold, and a pump. The vat contains a mixture that includes resin, plasticizer, stabilizer, oil, and sugar. The mixing mechanism mixes the mixture in the vat. The mold forms a fishing lure of a desired shape. The pump pumps the mixture from the vat into the mold.

### CROSS-REFERENCE TO RELATED APPLICATION AND CLAIM OF PRIORITY

The present application is related to U.S. Provisional Patent Application No. 61/843,728, which was filed on Jul. 8, 2013, and is entitled “Method and Apparatus for Fishing Lure Made with Sugar.” Provisional Patent No. 61/843,728 is hereby incorporated by reference into the present application as if fully set forth herein. The present application hereby claims priority under 35 U.S.C. §119(e) to U.S. Provisional Patent No. 61/843,728.

### TECHNICAL FIELD

The present application relates generally to fishing lures and, more specifically, to a method and apparatus for a fishing lure made with sugar.

### BACKGROUND

Flexible PVC fishing lures have been used to catch fish for many years. Flexible PVC lures have been produced with di(2-ethylhexyl)adipate (DOA) plasticizer and di(2-ethylhexyl) phthalate (DOP) plasticizer combinations. In other lures, high cost DOA plasticizer has been replaced with lower cost extender oils. In still other lures, due to concerns with toxicity, DOP plasticizer has been replaced by di-isononyl phthalate (DINP) plasticizer.

Over the years, many materials have been added to flexible PVC lures. Additives include salt, fish oils, crayfish, anise oil and the like. Salt is a widely used additive for fishing lures. However salt tends to increase the viscosity of the liquid plastic, increase the specific gravity of the baits and to abrade pumps, line and other plastic processing equipment.

Therefore, there is a need in the art for improved methods and systems for fabricating fishing lures.

### SUMMARY OF THE INVENTION

To address the problems inherent in the prior art, a method and apparatus are provided for a fishing lure made with sugar. In one embodiment of the disclosure, a system is provided. The system includes a mixing vat, a mixing mechanism, a mold, and a pump. The vat contains a mixture that includes resin, plasticizer, stabilizer, oil, and sugar. The mixing mechanism is configured to mix the mixture in the vat. The mold is configured to form a fishing lure of a desired shape. The pump is configured to pump the mixture from the vat into the mold.

In another embodiment of the disclosure, a method of producing a fishing lure including sugar is provided. The method includes mixing resin, plasticizer, stabilizer, oil, and sugar and pumping the mixture into a mold that is configured to produce a fishing lure having a desired shape. The method further includes allowing the mixture to set in the mold and removing the fishing lure from the mold.

In yet another embodiment of the disclosure, a molded fishing lure includes resin, plasticizer, stabilizer, oil, and sugar.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 presents an apparatus for making fishing lures with sugar according to an exemplary embodiment of the disclosure;

FIG. 2 presents a procedure for making fishing lures with sugar according to an exemplary embodiment of the disclosure; and

FIG. 3 presents a fishing lure with sugar according to an exemplary embodiment of the disclosure.

### DETAILED DESCRIPTION

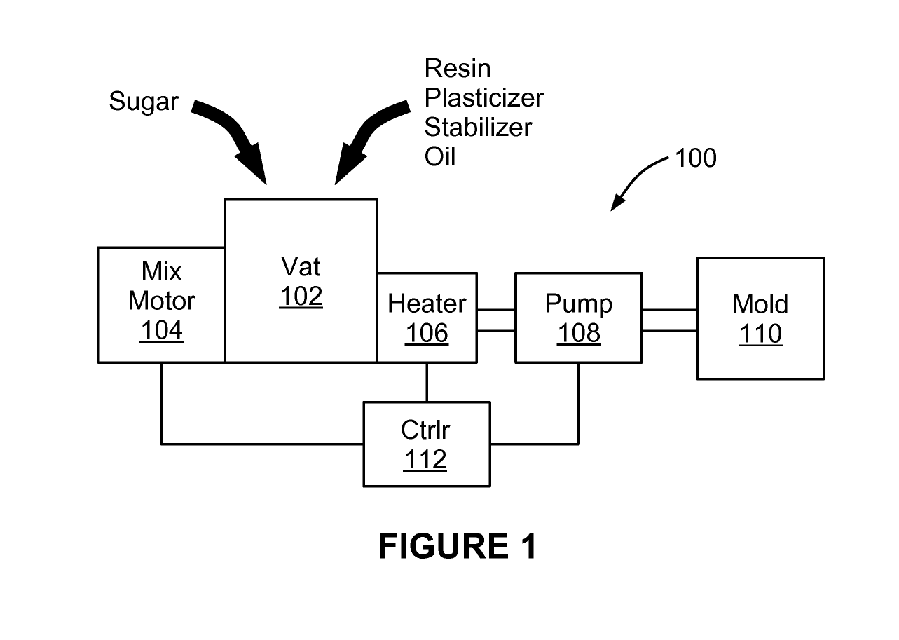

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged method and apparatus for production of fishing lures with sugar.

The present disclosure relates to an apparatus and method for making fishing lures with sugar. The lures may be molded in any suitable shape. Other materials may be included in the lures, in addition to sugar.

FIG. 1 presents an apparatus 100 for making fishing lures with sugar according to an exemplary embodiment of the disclosure. Resins, plasticizers, stabilizers, and oils are placed in a mixing vat 102. Proportions and quantities of such materials are discussed in greater detail below. Also added to the vat 102 is sugar. Pigments, glitter, and/or other ingredients suitable to change an appearance of the lure may also be added to the vat 102.

The system 100 further includes a mixer motor 104 operating an impeller (not shown) within the vat 102 to mix the combined ingredients in the vat 102. The mixer motor 104 and the impeller comprise a mixing mechanism of the system 100.

Where needed, a heater 106 may warm the mixture to a homogeneous consistency that can be pumped by a pump 108 into a mold 110 and fill the cavities of the mold 110. The heater 106 may heat the mixture in the vat 102 or in a pipe coupling the vat 102 to the pump 108. The mixture is then allowed to set in the mold 110, taking on a shape determined by the mold 110. Once set, the finished fishing lures are then removed from the mold 110.

In a similar way, additional material from the vat 102 may be pumped by the pump 108 into the mold 110, in order to fabricate more fishing lures. The process is repeated until all of the mixture in the vat 102 has been used. At that time, a new mixture may be prepared in the vat 102 to fabricate further fishing lures.

In some embodiments, the elements of the system 100 may be operated manually. In other embodiments, a controller 112 may control one or more elements of the system 100. In some such embodiments, the controller 112 may be a hardware controller comprising elements such as mechanical timers, relays, limit switches, and the like. In other such embodiments, the controller 112 may be a conventional computer-based controller, comprising an interconnected processor, memory, power supply, input/output interface circuitry (configured to couple to the elements of the system 100 being operated), and a user interface such as a display and one or more input devices, configured to enable a user to operate the system 100 via the controller 112.

Flexible PVC fishing lures are produced with a wide range of softness and flexibility. Harder baits intended for saltwater fishing are lower in plasticizer content, which makes these lures harder and tougher than freshwater baits. The amount of salt that can be added to a hard plastic is limited because the viscosity increase imparted by the salt makes the plastic difficult to process.

Listed in Table 1 are typical polyvinyl chloride (PVC) formulas used to produce soft freshwater baits and harder and tougher saltwater baits containing salt. Quantities in Table 1 are expressed in parts—that is, the quantities represent relative amounts of each material. Persons of skill in the art will understand that other ingredients and other proportions may be used without departing from the scope of the disclosure.

TABLE 1

| Ingredients | Soft | Medium Hard | Hard |
|---|---|---|---|
| PVC Resin | 100 | 100 | 100 |
| DINP Plasticizer | 623 | 543 | 486 |
| Epoxy Soybean Oil | 15 | 15 | 15 |
| Mixed Metal Stabilizer | 15 | 15 | 15 |
| Secondary Plasticizer | 188 | 180 | 137 |
| Salt | 118-236 | 118-236 | 118-236 |

PVC lures may be made according to the mixture described in Table 1 or other suitable mixtures, where granulated sugar is included instead of salt. In such mixtures sugar may be used in higher proportions than salt. It is believed that this is due to the irregular shape of the ground sugar compared with the much more regular cubical shape of salt.

The density of table salt is 2.16 grams per cubic centimeter (cc), or 18 pounds per gallon. For sugar, the density is 1.59 g/cc, or 13.3 pounds/gallon. Thus, lower density lures may be produced with sugar than with salt.

In trials conducted it was discovered that between 1 and 3 pounds of sugar may be added to one gallon of liquid plastic mixture and the plastic remains easily processed to mold soft plastic fishing lures. If an equivalent amount of salt is added to one gallon of plastic, the mixture is much more difficult to process with molding equipment currently used. Specifically, a mixture made with salt is more viscous; results in greater abrasion of pumps, lines, and other processing equipment; and produces lures having a higher specific gravity, than a mixture made with sugar.

Particularly for mixtures producing harder lures, more sugar can be added to the mixture than salt before the mixture is too viscous to be pumped and molded. As such, hard lures having a higher specific gravity may be fabricated using sugar in place of salt.

Further, sugar may be used to produce a lure having greater flavor for a desired specific gravity. Specific gravity for a lure may be selected in order to produce a desired rate at which the lure sinks in the water.

Additionally, a lure with a higher specific gravity may be produced from a less viscous mixture by using sugar in place of salt.

A further benefit is that sugar settles out of the liquid plastic at a reduced rate compared with salt. In some embodiments, the vat 102 may be configured with valves and couplers so that it can be decoupled from the molding system 100 and set aside before all the mixture in the vat 102 has been used. A second vat 102 containing a different mixture of ingredients may then be coupled to the molding system 100 and lures of different characteristics molded from a mixture in the second vat 102.

While the first vat 102 is in storage, the materials in the mixture typically settle out. When the first vat 102 is to be reconnected to the molding system 100 to resume making lures from the mixture therein, the mixture must be remixed. When salt settles, remixing the mixture and re-dispersing the salt requires much manual stirring followed by machine stirring to obtain a plastic that can be processed. With sugar, settling of the sugar occurs at a reduced rate and such intensive manual labor is typically not required.

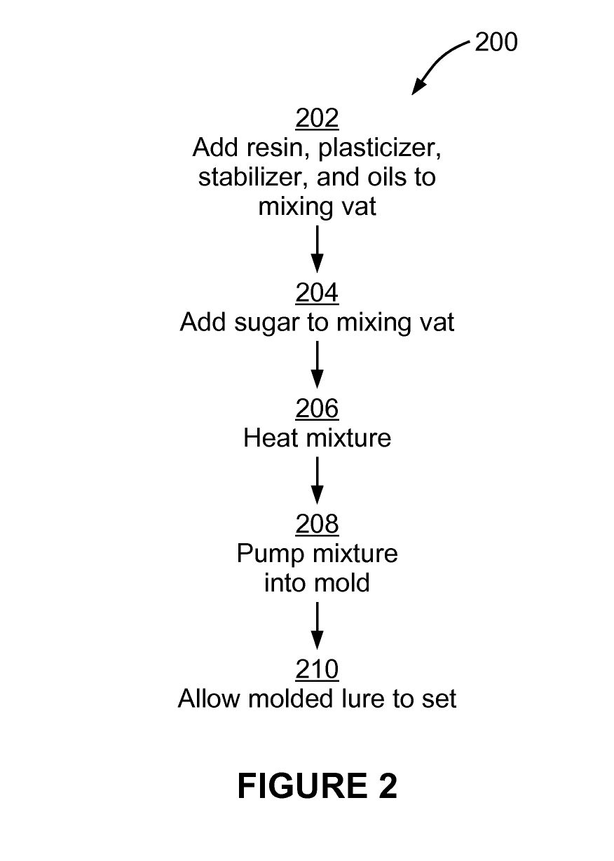

FIG. 2 presents a procedure 200 for making fishing lures with sugar according to an exemplary embodiment of the disclosure. Describing the procedure 200 with reference to the system 100 shown in FIG. 1, in step 202, resins, plasticizers, stabilizers, and oils in desired amounts are placed in the mixing vat 102 and are mixed. In step 204, sugar in a desired amount is added to the vat 102 and the combined materials further mixed. In other embodiments of the procedure 200, pigments, glitter, and/or other suitable materials may be added to the vat 102 in step 202, step 204, or in a subsequent step (not shown), and the combined materials further mixed. In optional step 206, the heater 106 heats the mixture to a desired viscosity and, in step 208, the pump 108 pumps the mixture into the mold 110. In step 210, the mixture is permitted to set in the mold 110 and in a subsequent step (not shown), the resulting molded fishing lures are removed from the mold 110.

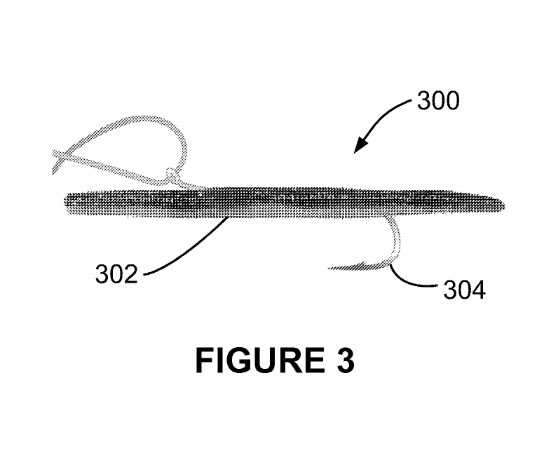

FIG. 3 presents a fishing lure 300 according to an exemplary embodiment of the disclosure. The lure 300 comprises a body 302 molded according to the procedure 200, described with reference to FIG. 2, using the system 100, described with reference to FIG. 1.

The lure may further include a fishing hook 304 coupled to the body 302. While FIG. 3 shows a single hook 304, it will be understood that in other embodiments, two or more hooks 304 may be included in the lure 300. While FIG. 3 shows the hook 304 extending from opposite sides of the body 302, it will be understood that the hook 304 may be coupled to the body 302 with any element of the hook 304 extending from any side of the body 302.

In some embodiments, the hook 304 is coupled to the body 302 after the body 302 is removed from the mold 110. In other embodiments, the hook 304 may be placed in the mold 110 prior to the mixture being pumped into the mold 110 and coupled to the body 302 as the mixture sets in the mold 110.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A system for molding a fishing lure including sugar, the system comprising:
a mixing vat containing a mixture comprising resin, plasticizer, stabilizer, oil, and sugar;
a mixing mechanism configured to mix the mixture in the vat;
a mold configured to form a fishing lure of a desired shape; and
a pump configured to pump the mixture from the vat into the mold.

2. The system of claim 1, further comprising a heater configured to heat the mixture prior to the pump pumping the mixture into the mold.

3. The system of claim 2, wherein the heater heats the mixture in a pipe coupling the vat to the pump.

4. The system of claim 1, wherein the mixture comprises a base mixture including 100 parts PVC resin, 486-623 parts DINP plasticizer, 15 parts epoxy soybean oil, 15 parts mixed metal stabilizer, and 137-188 parts secondary plasticizer, with granulated sugar added in the proportion of 1-3 pounds of sugar per gallon of base mixture.

5. The system of claim 1, wherein the mixture further comprises an ingredient suitable to change an appearance of the fishing lure.

6. The system of claim 4, wherein the ingredient is one of a pigment and glitter.

7. The system of claim 1, wherein the vat is configured to uncouple from the system while retaining the mixture in the vat.

8. The system of claim 6, wherein a second mixing vat is coupled to the system, the second vat containing a mixture different than the mixture in the first vat.

9. The system of claim 1, further comprising a controller coupled to at least one of the mixing mechanism and the pump, wherein the controller is configured to operate the at least one of the mixing mechanism and the pump.

10. The system of claim 9, wherein the controller comprises a processor, memory, power supply, and input/output interface circuitry coupled to the at least one of the mixing mechanism and the pump.

11. A method of producing a fishing lure including sugar, the method comprising:
mixing resin, plasticizer, stabilizer, oil, and sugar;
pumping the mixture into a mold configured to produce a fishing lure having a desired shape;
allowing the mixture to set in the mold; and
removing the fishing lure from the mold.

12. The method of claim 11, further comprising heating the mixture prior to pumping the mixture into the mold.

13. The method of claim 11, wherein the step of mixing comprises:
mixing a base mixture that includes 100 parts PVC resin, 486-623 parts DINP plasticizer, 15 parts epoxy soybean oil, 15 parts mixed metal stabilizer, and 137-188 parts secondary plasticizer; and
mixing the base mixture with granulated sugar in the proportion of 1-3 pounds of sugar per gallon of base mixture.

14. The method of claim 11, wherein the step of mixing further comprises mixing an additional ingredient suitable to change an appearance of the fishing lure.

15. The method of claim 14, wherein the additional ingredient is one of a pigment and glitter.

16. The method of claim 11, wherein the resin, plasticizer, stabilizer, oil, and sugar are mixed to form a first mixture in a first vat of a system and the first mixture is pumped from the first vat to the mold, the method further comprising:
uncoupling the first vat from the system while retaining the first mixture in the first vat;
coupling a second vat containing a second mixture to the system, wherein the second mixture is different than the first mixture; and
pumping the second mixture into the mold.

17. A molded fishing lure comprising:
resin:
plasticizer;
stabilizer;
oil; and
sugar.

18. The fishing lure of claim 17, further comprising:
a base mixture comprising:
100 parts PVC resin;
486-623 parts DINP plasticizer;
15 parts epoxy soybean oil;
15 parts mixed metal stabilizer; and
137-188 parts secondary plasticizer; and
granulated sugar in the proportion of 1-3 pounds of sugar per gallon of base mixture.

19. The fishing lure of claim 17, further comprising an ingredient suitable to change an appearance of the fishing lure.

20. The fishing lure of claim 19, wherein the ingredient is one of a pigment and glitter.
